(19) United States
(12) Patent Application Publication
(10) Pub. No.: US 2018/0116401 A1
(43) Pub. Date: May 3, 2018

(54) RACK POST PROTECTION APPARATUS

(71) Applicant: Jin Ok KIM, Seoul (KR)

(72) Inventor: Jin Ok KIM, Seoul (KR)

(21) Appl. No.: 15/338,677

(22) Filed: Oct. 31, 2016

(51) Int. Cl. A47B 97/00; A47B 96/14; B60Q 9/00

(52) U.S. Cl. CPC A47B 97/00; B60Q 9/008; A47B 96/145

(57) ABSTRACT

Provided is a rack post protection apparatus, which may include a cover wherein a cut-away part corresponding to the width of a rack post is provided in the longitudinal direction of a pipe-shaped body; an installation space part formed at the cover; and a communication module which is installed at the installation space and is formed of a transmission module and a collision detection sensor, thus quickly coping with any collision.

### BACKGROUND

The present invention relates to a rack post protection apparatus, and in particular to a rack post protection apparatus wherein an attachment and detachment are easy, and an installation work may be simplified, and the front side and both lateral sides of a rack post which are exposed to the outside can be protected.

A rack structure (hereinafter referred to “a rack”), in general, is used to effectively display or sell products packed in a box or a pallet or store various goods at a warehouse, a storage type shop, etc.

The rack is formed of a plurality of posts which are installed vertical and spaced apart at set intervals, a plurality of load beams which are installed traversing between the posts in horizontal directions, and a plurality of tie beams which are installed in the direction traversing between the rod beams.

The shape and structure of the rack post is schematically illustrated in FIG. 1. The typical rack post (P) is configured in such a way that a front side part (P-1) protrudes forward, and a groove (P-3) is formed at both lateral surfaces (P-2) while opposing to each other. Moreover, three lateral surfaces formed of the front surface (P-1) and both lateral surfaces (P-2) are exposed to the outside.

The three lateral surfaces of the post (P) exposed to the outsides may collide with goods when the goods are loaded or unloaded, thus causing damages to the goods. If a worker passing along a passage collides with a protruding corner of the rack post (P), the worker may be injured, thus causing an accident.

As a prior art related with the present invention, there is the Korean patent laid-open number 2012-0137977 (the laid-open date: Dec. 24, 2012), which describes a rack structure for a warehouse and stacking having a prefabricated structure.

### SUMMARY OF THE INVENTION

Accordingly, it is an object of the present invention to provide a rack post protection apparatus wherein an attachment and detachment are easy, and an installation work may be simplified, and the front surface and both lateral surfaces of a rack post which are exposed to the outside can be protected.

It is another object of the present invention to provide a rack post protection apparatus wherein when the protection apparatus detects any collision, the position of such a collision can be transmitted to a manager.

The solutions provided by the present invention are not limited to the aforementioned solutions, and other solutions not mentioned herein will be obviously understood to a person having ordinary skill in the art.

To achieve the above objects, there is provided a rack post protection apparatus which may include a cover wherein a cut-away part corresponding to the width of a rack post is formed in the longitudinal direction of a pipe-shaped body, and a lattice frame reinforcing body is formed integral at an inner wall of the cover, and there is further provided a tying member configured to fix in an attaching and detaching manner the rack post protection apparatus and the rack post while covering the outer surface of the cover installed at the rack post.

Moreover, the width of the cut-away part is same as or smaller than the width of the rack post, and a pair of extension plates protrude in parallel from both ends of the cut-away part and in the direction of the rack post, and the extension plates may contact close with both lateral sides of the rack post and are engaged.

In addition, a collision detection sensor operated by a battery may be embedded at the top of the cover, and if a collision is detected, the position of the collision may be transmitted to a main server via a wireless network, and the main server may transmit a corresponding content to a manager's computer, so the manager can confirm the collision.

According to the present invention, the attachment and detachment of the rack post protection apparatus is easy, and an installation time thereof can be saved, and a work convenience can be enhanced.

The rack post protection apparatus is able to provide a simplified structure and is made of a synthetic resin, for which a formability is good, and a manufacturing cost can be saved, and a product competitiveness can be enhanced.

Moreover, since a plurality of rack post protection apparatuses may be installed connected to each other for multiple layers, and the length thereof can be adjusted based on any change to the length of the rack post.

In addition, it does not need to use an additional protection member which may be installed at a front surface and both lateral surfaces of a rack post, and three surfaces of a rack post can be simultaneously protected through a simplified installation work.

Furthermore, any collision can be detected using a built-in collision detection sensor, and a collision position can be transmitted to a manager, thus quickly recognizing any damage to a protection apparatus.

### BRIEF DESCRIPTION OF THE DRAWINGS

The present invention will become better understood with reference to the accompanying drawings which are given only by way of illustration and thus are not limitative of the present invention, wherein;

FIG. 1 is a schematic perspective view illustrating a rack post;

FIG. 2 is a detailed perspective view illustrating a rack post protection apparatus according to the present invention;

FIG. 3 is a view for describing an implementation of a rack post protection apparatus according to the present invention;

FIG. 4 is a cross sectional view illustrating a state before the installation of a rack post protection apparatus according to the present invention;

FIGS. 5 and 6 are views for describing an installation of a rack post protection apparatus according to the present invention;

FIG. 7 is a view for describing a wireless communication of a rack post protection apparatus; and

FIG. 8 is a view for describing an implementation of a rack post protection apparatus according to an embodiment of the present invention.

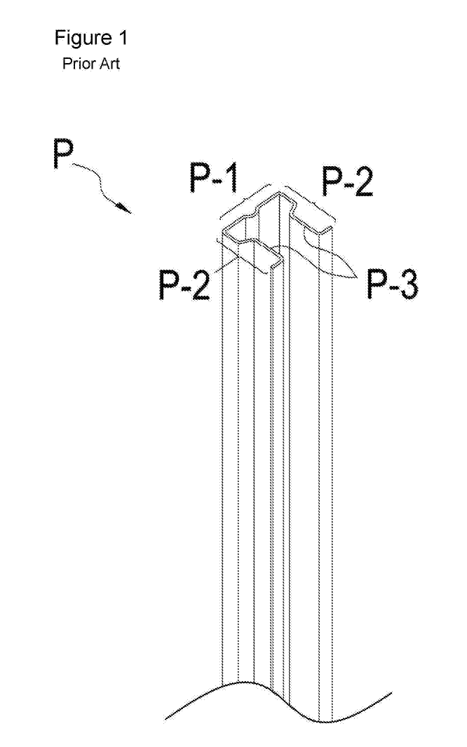

### DETAILED DESCRIPTION OF THE INVENTION

The rack post protection apparatus according to an embodiment of the present invention will be described with reference to the accompanying drawings.

The rack (or a rack structure) represents a structure which is manufactured and used to display sell products packed in a box or a pallet or store such products at a warehouse, a storage type shop, etc.

Moreover, the rack posts may be referred to a plurality of support members which are installed vertical at a rack structure and are disposed in parallel at regular intervals.

The rack post protection apparatus is referred to an apparatus which is able to prevent any damage and breakage of the rack posts disposed in the above-described structure and prevent any accident which might occur when a worker collides with a rack post.

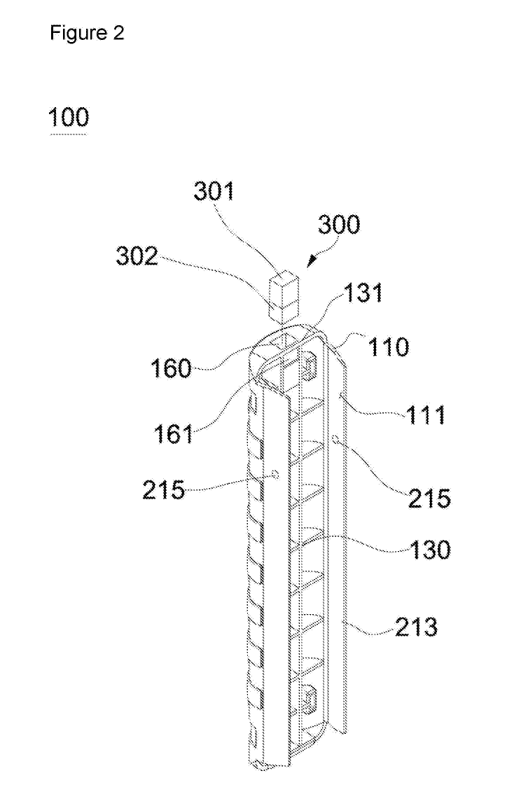

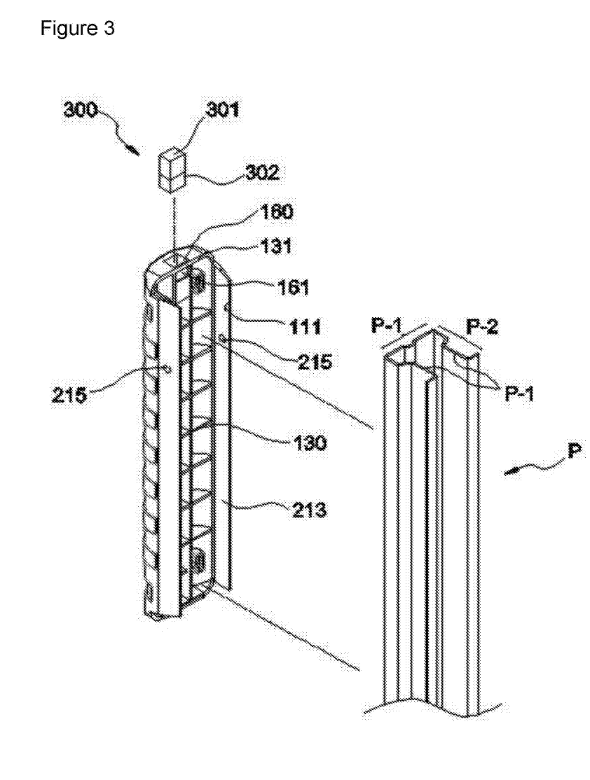

FIG. 2 is a detailed perspective view illustrating a rack post protection apparatus according to the present invention, and FIG. 3 is a view for describing an implementation of a rack post protection apparatus according to the present invention.

As illustrated in FIGS. 2 and 3, the rack post protection apparatus 100 according to the present invention may include a cover 110; and a honeycomb-shaped lattice frame reinforcing body 130 which is provided integral at the inner wall of the cover 110.

The cover 110 is a member made of a synthetic resin wherein a cut-away part corresponding to the width of the rack post is disposed in the longitudinal direction of a pipe-shaped body.

The cover 110 may have a predetermined set length and may include a pipe-shaped body, and a cut-away part 111 corresponding to the width of the rack post may be provided at the cover 110.

The width of the cut-away part 111 formed at the cover 110 may be same as the width of the rack post or may be smaller than the width thereof. When the cover 110 is installed at the rack post, the front surface (P-1 in FIG. 3) and both lateral surfaces (P-2 in FIG. 3) of the rack post may contact close with the cut-away part 111.

The cover 110 may be made of a synthetic resin material, in particular, a plastic material. As a specific example, a polycarbonate may be used.

This material may contribute to a stronger durability when an external impact is applied through the cover 110 and a good flexibility through the cut-away part 111 when attaching or detaching the cover 110, by which the width of the cut-away part can be contracted as it is widened or recovered.

The shape of the outer wall of the cover is not limited to the disclosed embodiment and may be reinforced or modified into various forms so as to secure a high strength and flexibility.

The rack post protection apparatus 100 may be installed at a rack post using the cut-away part 111.

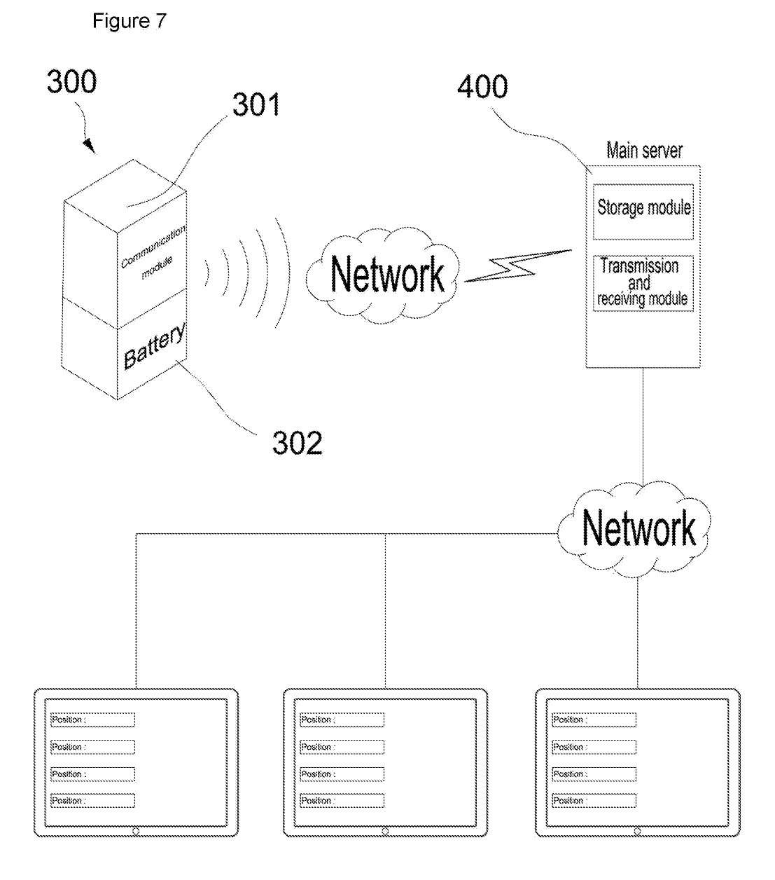

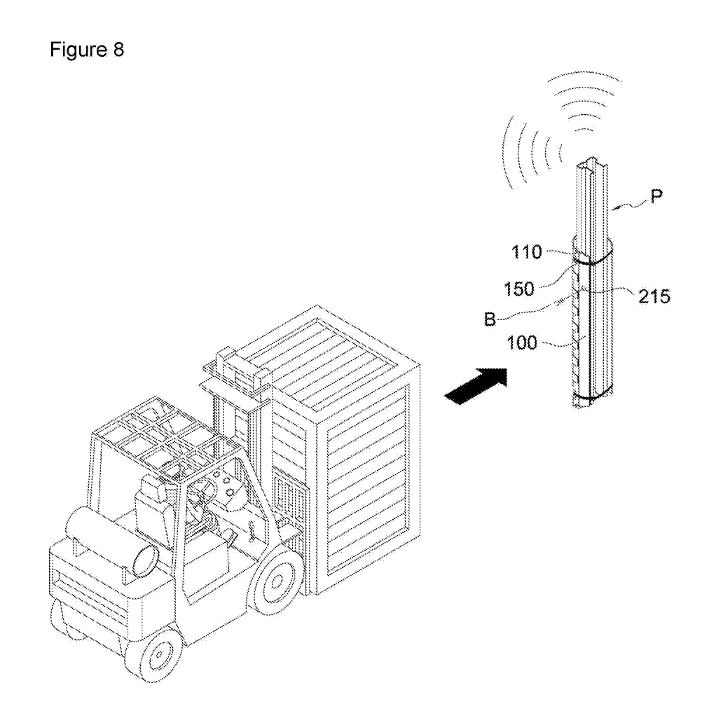

An installation part 160 may be perforated at the upper surface of the cover, so an installation space part 161 can be provided. A communication module 300 can be inserted and installed thereat. The communication module may be formed of a transmission module 301 operated by a battery (not illustrated) and a collision detection sensor 302. As illustrated in FIG. 7, the communication module installed in the installation space part is able to transmit a corresponding collision position to a transmission and receiving module of a main server 400 in such a way to use the transmission module 301 if the collision detection sensor detects any collision, and the main server stores the collision position in a storing module and transmits to a manager's computer through the transmission and receiving module, after which a manager can recognize the collision position using the manager's computer 500, so the manager can quickly cope with such a collision. The communication between the communication module, the main server and the manager's computer 500 may be carried out through a wired or wireless network. Since the position confirmation can be estimated based on various communication protocol technologies, for example, a GPS, a RFID tag, a Wi-Fi, etc., the description thereof will be omitted.

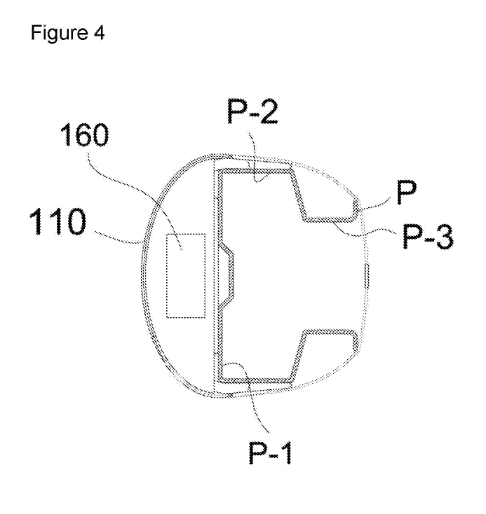

The installation procedure of the rack post protection apparatus according to the present invention will be described with reference to FIGS. 3 to 5.

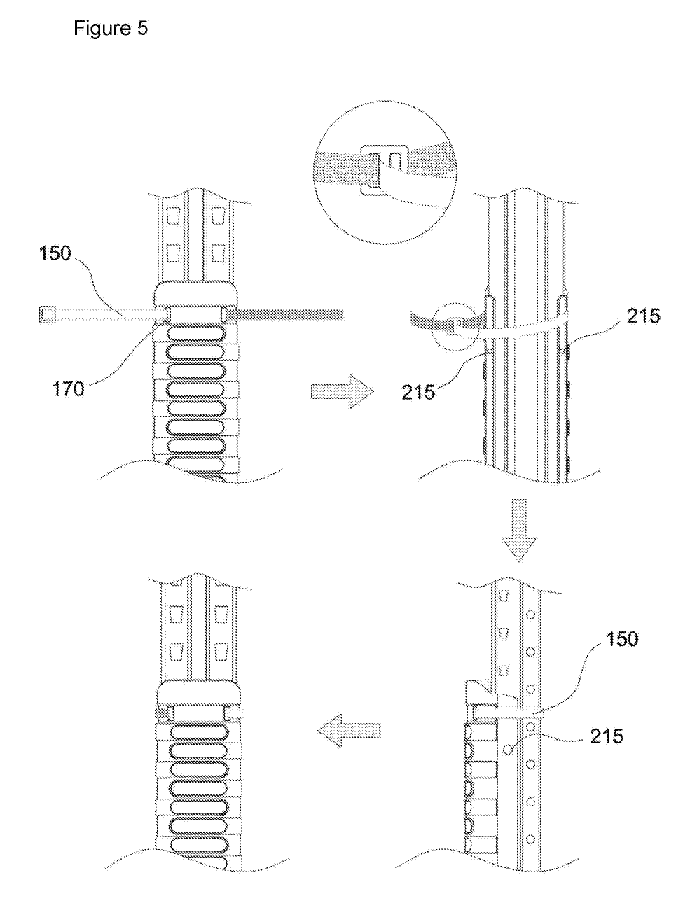

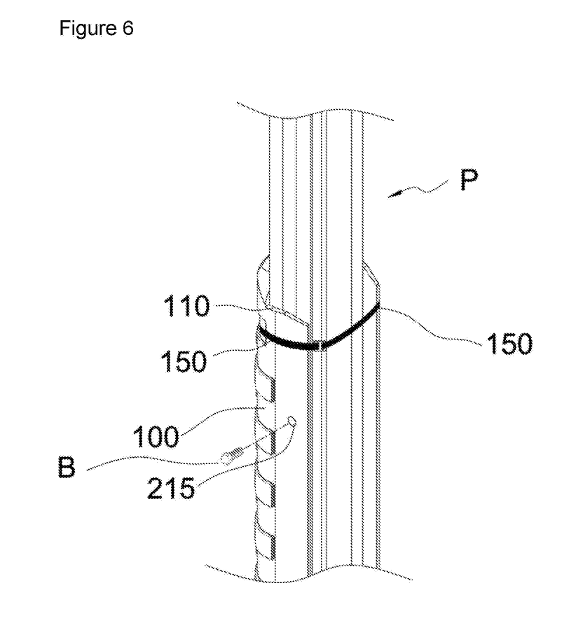

FIGS. 3 and 5 are disassembled perspective views illustrating a state before a rack post protection apparatus is installed according to the present invention. Referring to FIG. 3, it shows only one rack post (P) in the whole rack structure for the sake of a simplified illustration. A rack post protection apparatus 100 is disposed at one side before it is installed at the rack post (P).

Like a typical rack post (P), a front surface thereof (P-1) protrudes forward, and a groove (P-3) formed contacting close with the cut-away part 111 of the cover 110 is provided at both lateral surfaces (P-2). The exterior of the rack post (P) before the rack post protection apparatus 100 is installed is like a configuration wherein three surfaces are exposed to the outside.

Since the cover 110 made of a synthetic resin material is flexible, the width of the cut-away part 111 can be widened or contracted within a predetermined range, so it can be installed at a rack post (P) in such a way to spread an extension plate 213 of the cut-away part 111 of the cover 110.

FIG. 5 is a view for describing an implementation wherein a protection apparatus is fixed and engaged stable to a rack post using a string-shaped tying member 150 and a through hole 170. The through hole is perforated at the cover, and the string-shaped tying member is inserted through the through hole and is tied to the rack post, by which the protection apparatus can be fixedly engaged stable to the rack post. In this way, the installation time of the rack post protection apparatus 100 can be saved, and the installation work can be carried out in an easier way.

The tying member 150 is referred to a string (or a band) member which can be attached or detached like a Velcro type (or a belt type) member and may cover the outer surface of the cover 110 installed at the rack post (P), thus stably fixing the connection state between the rack post (P) and the rack post protection apparatus 100.

The length of the rack post protection apparatus 100 may be adjusted in response to any change to the length of the rack post (P). In this case, a plurality of the rack post protection apparatuses 100 may be connected, thus building a multi-layer structure.

Moreover, a pair of extension plates 213 may be provide at both ends of the cut-away part 111 of the cover 110 and protrude in parallel toward the rack post (P). An engaging hole 215 is formed at an upper end or a lower end of the extension plate. The cover may be fixed at the rack post using a bolt (B).

The rack post protection apparatus according to an embodiment of the present invention can be easily attached or detached, so installation time can be saved, and a work convenience can be enhanced.

Since the configuration of the rack post protection apparatus is simplified and is made of a synthetic resin material or a high flexibility sponge material, formability is good, and the manufacturing cost can be saved, which may result in an enhanced product competitiveness.

Moreover, since a plurality of the rack post protection apparatuses can be interconnected, thus building a multi-layer structure, the length thereof can be adjusted in response to any change to the length of the rack post.

In addition, the three surfaces of the rack post can be protected through a simple installation work without using an additional protection device which is installed at each of the front surface and both lateral surfaces of the rack post.

So far, the rack post protection apparatus according to the present invention has been described in detail.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A rack post protection apparatus, comprising:
a cover wherein a cut-away part corresponding to a width of a rack post is formed in a longitudinal direction of a pipe-shaped body;
a lattice-shaped reinforcing body which is honeycomb-shaped and formed at an inner wall of the cover integrally with the inner wall of the cover and comprises a plurality of vertical wall portions and a plurality of horizontal wall portions protruding from the inner wall of the cover, so as to reinforcing the rack post protection apparatus;
a pair of extension plates which protrude in parallel from both ends of the cut-away part in a direction of the rack post; and
a tying member which is configured to cover an outer surface of the cover installed at the rack post and is able to fix in an attaching or detaching manner the rack post protection apparatus and the rack post.

2. The apparatus of claim 1, further comprising:
an installation part which is provided at an upper surface of the cover and is perforated to define an installation space part;
a communication device which is embedded in the installation space part through the installation part and is operable by a battery and is equipped with a transmission device and a collision detection sensor;
a main server which is equipped with a storage device and a transmission and receiving device; and
a manager's computer which is configured to receive a collision position from the main server, wherein if the collision detection sensor of the rack post protection apparatus installed at the rack post detects a collision, the collision position is transmitted to the transmission and receiving device of the main server through the transmission device and is stored in the storage device and then is transmitted to the manager's computer, thus quickly coping with any collision.

3. The apparatus of claim 1, further comprising:
a pair of engaging holes formed at the pair of extension plates, so the cover can be fixed at the rack post using a bolt (B).

4. The apparatus of claim 1, further comprising:
a through hole perforated at the cover, wherein a string member is inserted through the through hole and is tied to the rack post, by which the rack post protection apparatus can be stably fixed at the rack post.

5. (canceled)

6. The apparatus of claim 1, wherein the tying member is Velcro® or belt.
